(19) United States
(12) Patent Application Publication
(10) Pub. No.: US 2020/0394706 A1
(43) Pub. Date: Dec. 17, 2020

(54) SHARED HOME OWNERSHIP FOR FIRST TIME HOME BUYERS

(71) Applicant: Nicholas A. Colachis, Los Angeles, CA (US)

(72) Inventor: Nicholas A. Colachis, Los Angeles, CA (US)

(21) Appl. No.: 16/903,314

(22) Filed: Jun. 16, 2020

Related U.S. Application Data
(60) Provisional application No. 62/862,534, filed on Jun. 17, 2019.
(60) Provisional application No. 62/985,719, filed on Mar. 5, 2020.
(60) Provisional application No. 63/036,689, filed on Jun. 9, 2020.

(51) Int. Cl. G06Q 30/08; G06Q 50/16; G06Q 40/02; G06Q 40/04; G06Q 40/08; G06Q 50/26; G06Q 50/18; G06Q 10/10; G06Q 30/00

(52) U.S. Cl. CPC G06Q 30/08; G06Q 50/167; G06Q 40/025; G06Q 40/04; G06Q 30/0203; G06Q 50/26; G06Q 50/18; G06Q 10/10; G06Q 30/012; G06Q 40/08

(57) ABSTRACT

By matching several unrelated people together to purchase a home, their buying power (combined net income) is significantly increased, and they can qualify for a shared home (or condominium) that offers more amenities and is in a better location than they could otherwise afford. Moreover, such a shared home purchase not only will probably increase in value, it may qualify for special tax treatment. In a presently contemplated embodiment, a “Facilitator” matches potential buyers (preferably by questionnaires and computer algorithms) based on personality traits, 5-year goals, FICO scores, financial worth, and/or where and the maximum distance (in miles and/or travel time) far they want to live within miles of their jobs. The Facilitator not only introduces “matched” potential buyers to each other, but also helps them find an appropriate home (or condominium) and obtain the necessary financing, preferably using the services of affiliated real estate brokers, mortgage companies, and insurance companies. The Facilitator's responsibilities preferably continue even after the matched buyers have completed escrow and have moved into their new home, including obtaining insurance for each buyer to protect against possible loss of income, and/or facilitating the sale of a particular individual's share in the event that individual dies or is disabled, and/or assisting one or more co-owners to exchange their share(s) for a more suitable residence that reflects changes in the co-owners' individual circumstances. In a presently preferred embodiment, the matched buyers of a particular home or condominium comprise at least three unrelated individuals or families. partnerships, with each individual or family occupying its own relatively small basic living unit (with private sleeping area, bathroom, and at least limited food preparation and storage), as well as a relatively large shared space for more formal food preparation and dining, as well as entertainment of guests.

### BACKGROUND

Mortgage companies are comfortable expanding credit and home loan financing for first time home buyers only if the potential buyer can demonstrate being a worthy borrower with sufficient buying power (income less expenses). Moreover, many first time potential home buyers have high debt (including substantial student debt which in the case of a recent graduate from Medical school can be as high as $400,000).

People in America today are finding it impossible to buy (finance) a new home. The home prices are too high for their Debt to Income ratio to qualify for a home that is to their standard of living. The average home in Los Angeles is $500,000 and is probably not anywhere near their work and might not be in a good area. The average price of a home in one of the nicer areas of Los Angeles is over $900,000.

A student that graduates from a University today will owe $120,000 to $240,000 in student debt. If they go to a graduate school for Nursing, Accounting, Finance, Law School, Medical School, etc., they will owe an additional $100,000 to $300,000. The average Medical student that graduates from Medical school owes over $400,000. In most towns in America, that is a home loan.

Becoming a homeowner is quintessential part of the ‘American dream’, so obtaining the right mortgage is a critical step in the first time home buyer process. It's no secret that the U.S. housing market has been surging, so it is natural that mortgage companies are comfortable expanding credit and home loan financing for first time home buyers that can demonstrate being a worthy borrower.

In Los Angeles, the average rent is $2,500 a month for a nice place in a nice area. Park La Brea is one of the largest apartment complexes in Los Angeles with almost 4,000 apartments. The average one bedroom is $2,500.

If a person graduates from college and pays $2,500 a month in rent, they will have paid $30,000 in rent in one year. In 10 years, they will have paid $300,000 in rent. In 20 years, $600,000 in rent. In 30 years, $900,000 in rent, and the rent is not tax deductible.

If a person makes $80,000 a year, they could save, after taxes, $10,000 a year. Assuming their salary stays the same, in 10 years, they would have saved $100,000. In 20 years, $200,000. In 30 years, $300,000. Thus, in 30 years, that person has paid $900,000 in rent (someone else's mortgage), and has saved only $300,000.

The average first-time home buyer down payment in Los Angeles today is $95,000. In San Francisco it is $127,000. What will be the down payment on a home in Los Angeles be in 30 years?

### SUMMARY

The problem of first-time home buyers, and others, is solved by a novel process that begins by matching people together to purchase a home. Together, their buying power is significantly greater.

A three-bedroom $1,500,000 home purchased by three people is only $500,000 each. With their existing debt, their Debt to Income ratio would be significantly reduced, and they could qualify for a home loan.

The mortgage loan payment with property taxes and insurance would be approximately $7,500 a month or $2,500 each; the same as rent they are paying for their apartment, but now they own a home. The interest on the loan and up to $10,000 in property taxes is deductible. This means each owner would save roughly $15,000 a year in taxes. In four years, they will have individually saved $100,000 ($60,000 taxes and $40,000 in savings). It would take them 10 years to save $100,000 each, but with our solution, they could do it in four years and see appreciation in their home value.

A suitable Questionnaire for applicants (“buyers”) may be in 4 sections: Personality. Goals. Job. Financials. A suitable software App is then used to match the potential buyers for a particular residence, using algorithms to match people of similar traits, personalities, 5-year goals, FICO scores, financial worth, and where and how far they want to live within miles of their jobs.

To ensure that the applicants are serious about purchasing a suitable residence, they may be charged a nominal fee (perhaps $9.95 per month) to join. When two or more applicants are matched at 75% or greater, they can contact each other and meet. Once they have met, they can spend time with each other and see if they get along well. The matched renters can then download a legally binding agreement that facilitates the joint purchase of a home. When they agree and sign, they can start to look for a home.

The Facilitator may align itself with a licensed real estate broker to assist the applicants to help find a home, as well as with a financial mortgage company to assist those potential buyers to obtain suitable financing, and with an insurance company to assist those buyers to obtain suitable casualty and liability insurance.

The Facilitator will preferably align itself with an insurance company to cover 6 months loan payments should any of the ‘collective’ owners lose their job, get disabled, or loss of life. During this time, the affected owner (or their legal representative) will have access to Facilitator's services to find another “owner” to fill their spot, rent their space, arrange with the remaining owners to sell the entire home, or negotiate a sale to the remaining owners.

In a presently preferred embodiment, the Facilitator may retain a nominal share (5% to 10%) of each property and will facilitate resolution of disputes between owners, as well as assist individual owners to find a new home in the event their current home is no longer suitable for their changed circumstances.

The Facilitator will preferably align itself with a developer to build condominium towers in highly desired areas to accommodate 3-bedroom units that are equal in room size and are customized for shared occupancy by Facilitator's clients. Each client/owner would have their own bathroom, their own balcony or other private area for relaxation and entertainment of guests, their own private snacking area including refrigerator and microwave, and preferably their own private entrance.=. They would share the main area kitchen and living space, also a “powder room” for guests.

### DRAWINGS

FIGS. 1 through 4 are floor plans of various arrangements of private and shared spaces within otherwise conventional homes or condominiums that could be shared by unrelated individuals, but which would require structural modifications in order to be particularly suited for long term occupancy by three or more unrelated individuals (or families).

FIG. 5 is a flowchart showing how a Facilitator may work with potential home buyers to identify suitable candidates for joint ownership and occupancy of a suitable housing unit.

### DETAILED DESCRIPTION OF A PRESENTLY PREFERRED EMBODIMENT

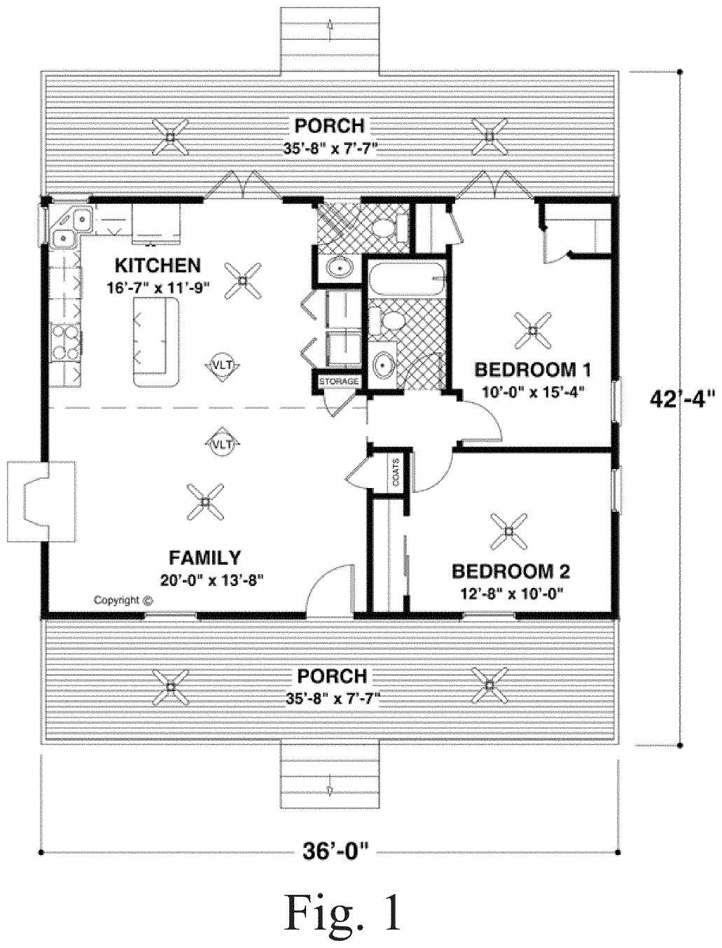

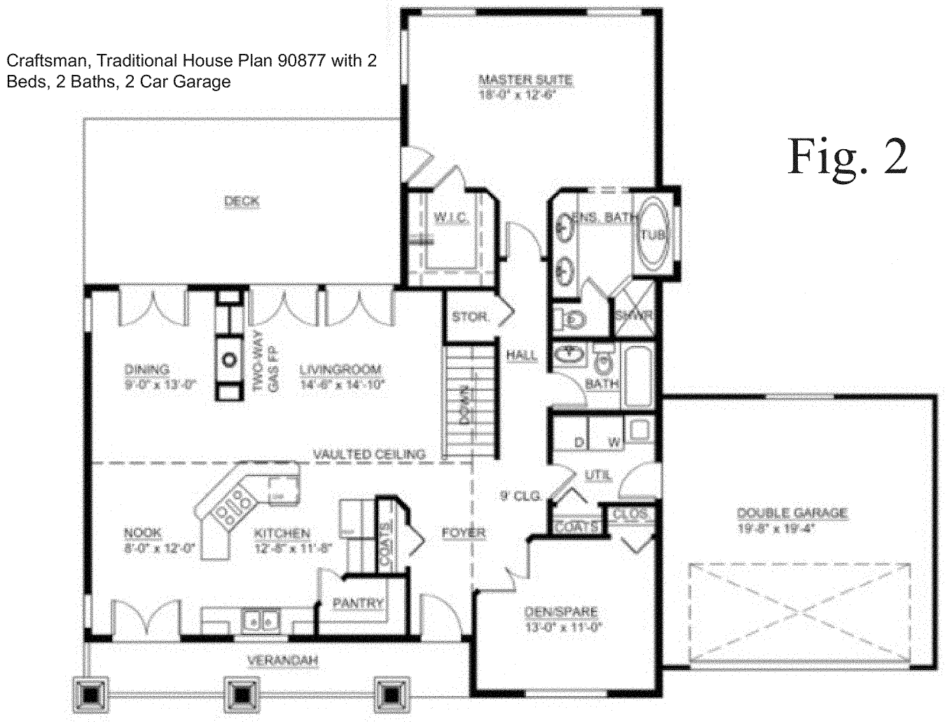

FIG. 1 shows a stand-alone dwelling unit having a shared family room and kitchen area with an adjacent half bath for guests as well as 2 private bedrooms each with its own closet and direct access to a respective porch but only shared access to a single private bathroom. FIG. 2 show a traditional house plan with 2 bedrooms, 2 baths, and a two car garage that could be shared by two unrelated individuals, however the second bedroom does not have its own private bath and is really intended to be used as a den or for guests. Neither floor plan would be suitable for occupancy by two unrelated buyers, but could be modified by adding a second private bath to the second bedroom.

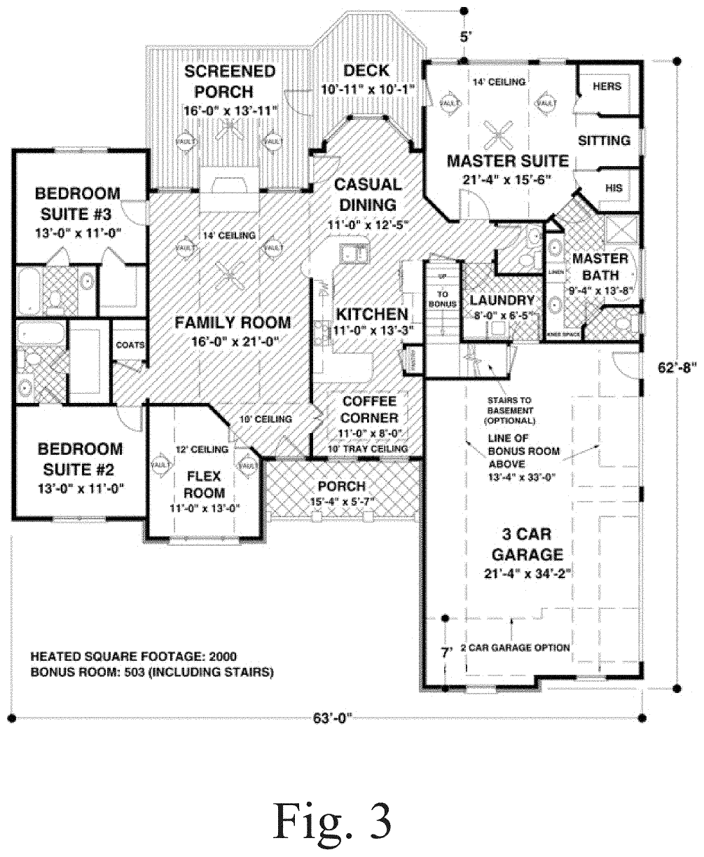

The floor plan shown in FIG. 3 does include 3 bathrooms each with its private bath, but presumably at least one of the bedrooms is used only by guests and its en suite bathroom is normally accessible to guests,

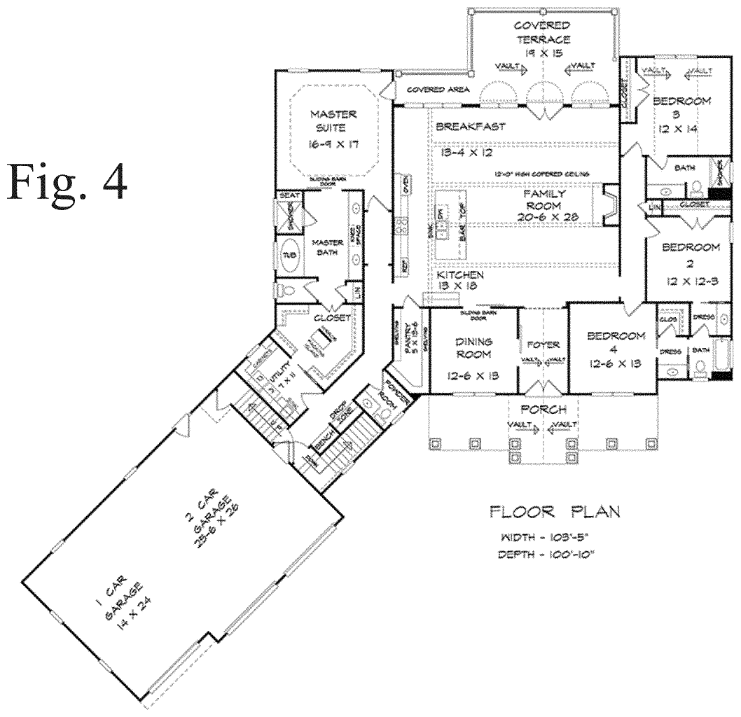

FIG. 4 shows a relatively large shared space including a covered terrace, a shared open living space including a foyer, a dining room. a covered terrace and a guest bedroom (or den) surrounding a large open living space comprising a large family room including an open kitchen area and an open breakfast area, as well as three private bedroom areas: “Master Suite”, “Bedroom 2” and “Bedroom 3”, each connected to a respective private bathroom and closet, but there are only 3 toilets and it is apparent that at least the toilet between bedroom 2 and bedroom 4 is intended to be accessible to guests, so the floor plan would require modification before it was suitable for full time occupancy by more than 2 unrelated individuals or families. In particular at least one private bathroom should be provided for exclusive use by each family, and each family should preferably have its own private entrance and its own private areas for not only sleeping, bathing and storage, but also for private eating and entertainment.

As shown in FIG. 5, the Facilitator advertises in all types of media for potential buyers to Go Online to Website of Facilitator or Call (Step 1). A potential buyer logs on to the Facilitator website, answers questions, fills in personal data, and starts searching for potential matches/partners to buy a home (Step 2). The Facilitator scores potential buyers on personalities, hobbies, lifestyle, education, likes, dislikes, job, income, money available for deposit on a home, credit score (FICA), and location within five miles to buy a home. (Step 3).

The facilitator then uses the uses the respective scores associated with each potential buyer to identify potential matches (Step 4) and the potential co-owners/matches identified by Facilitator are invited to meet each other and get to know each other. (Step 5) Optionally a Facilitator representative may contact some or all of the identified potential co-owners prior to any such meeting and if requested will be available to attend or otherwise facilitate their initial meeting.

Each potential co-owner (could be a single person, a couple, or a family sharing the same private area) then decides on price range of home, location, and if whether the home should have two, three or four bedrooms (2, 3, or 4 co-owners). (Step 6) Three or more bedrooms and three or more unrelated co-owners are preferable. That way any change to the shared home requiring approval by a majority of the co-owners could not be blocked by a single co-owner.

The potential buyers get financing pre-approval (preferably with a Facilitator approved bank) (Step 7) (and look for a home to buy (preferably with Facilitator approved Realtor) (Step 8) Once the potential buyers find a home that works, they use a Facilitator approved Partnership Agreement to make an offer on that home. (Step 9) If the offer is approved, the Facilitator arranges for the purchase (and preferably ongoing management and maintenance) of that home. (Step 10)

1. A method for providing benefits of home ownership to a person (or two or more related persons) not willing and able to purchase a single family home or condominium in a desired location, comprising:
maintaining a first data base of potential buyers ready, willing and able to share a suitable dwelling unit with other compatible buyers;
maintaining a second data base of available dwelling units suitable for multiple occupancy;
identifying potential matches of at least three potential buyers in the first data base with similar needs, resources and requirements;
providing the matched potential buyers with details of suitable dwelling units in the second data base;
obtaining financing for the matched potential buyers ready, willing and able to purchase a selected dwelling unit;
assisting the matched buyers in the purchase and occupancy of the selected dwelling unit
wherein:
each of the available dwelling units is suitable for occupancy by at least three unrelated owners and includes a shared area for meal preparation, entertainment and relaxation, and respective private areas for each owner including a dedicated area for sleeping, bathing and relaxing, as well as a secure area for storage of personal effects;
a management company preferably retains an agreed interest in each dwelling unit and is responsible for maintenance of common areas, payment of utilities, insurance, taxes and interest, and possible resale of each individual owner's share (including any interest held in trust by the management company) of the dwelling unit in the event of death, disability, or breakup of that owner; and
each individual owner qualifies as a home buyer under applicable IRS regulations, with taxes, interest, depreciation, utilities, insurance and maintenance allocated between the individual owners and the management company in accordance with a written agreement between the buyers and the management company, as may be modified from time to time per any applicable IRS regulations.

2. The method of claim 1, further comprising the step:
repurchasing at a guaranteed price from a matched buyer within a specified time period, that buyer's share of the selected property in the event that buyer is not satisfied with their ownership and occupancy of the selected dwelling unit,

3. A dwelling unit suitable for use and occupancy by at least three unrelated individuals and/or preexisting partnerships, comprising for each such individual or partnership, a dedicated private area for sleeping and bathing, as well for limited food storage, snacking, and for personal rest and recreation, as well as private computer access for personal business and recreation and a dedicated secure area for storage of personal effects, wherein each unrelated individual or partnership qualifies as a home buyer under applicable IRS regulations, with responsivity for taxes, interest, depreciation, utilities, insurance and maintenance allocated in accordance with a written agreement between the buyers and the management company, as may be modified from time to time per any applicable IRS regulations.

4. The dwelling unit of claim 3 wherein the management company optionally retains an agreed interest in, and/or security deposit for, each dwelling unit and is responsible for maintenance of common areas, and payment of utilities, insurance, taxes and interest.

5. The dwelling unit of claim 3 wherein the management company is responsible for the resale of each individual owner's share (including any interest held in trust by the management company) of the dwelling unit in the event of death or disability of that individual owner, and is accountable to the other owners for the distribution of any profits resulting from such a resale.

6. The dwelling unit of claim 3 wherein the individual dedicated private areas each have the same value.

7. The dwelling unit of claim 3 wherein the individual dedicated private areas have different values, based at least in part on the size, location, and/or included amenities.

8. The dwelling unit of claim 7 wherein the relative value of each dedicated private area is determined by an auction process.

9. The dwelling unit of claim 7 wherein the relative value of each dedicated private area is determined by the management company.
